(19) United States
(12) Patent Application Publication
(10) Pub. No.: US 2015/0355358 A1
(43) Pub. Date: Dec. 10, 2015

(54) GENERALIZED SPECTRAL DECOMPOSITION

(71) Applicant: Schlumberger Technology Corporation, Sugar Land, TX (US)

(72) Inventors: Victor Aarre, Stavanger (NO); Edo Hoekstra, Stavanger (NO)

(21) Appl. No.: 14/674,585

(22) Filed: Mar. 31, 2015

Related U.S. Application Data
(60) Provisional application No. 62/008,983, filed on Jun. 6, 2014.

(51) Int. Cl. G01V 1/36; E21B 47/00; E21B 7/00

(52) U.S. Cl. CPC G01V 1/366; E21B 7/00; E21B 47/00; G01V 2210/60; G01V 2210/23

(57) ABSTRACT

A method for decomposing a signal includes receiving sampled data. A wavelet is built using the sampled data that includes a plurality of samples. The wavelet includes a number of oscillations per sampling unit, and a length of the wavelet corresponds to the number of oscillations. The wavelet is time-shifted. The wavelet is then scaled such that the samples proximate to one or both ends of the wavelet decay toward zero. The wavelet is also scaled such that an amplitude at a peak frequency of the wavelet, when transformed into a Fourier domain, is substantially unity.

### CROSS-REFERENCE TO RELATED APPLICATION

This application claims priority to U.S. Provisional Patent Application having Ser. No. 62/008,983, filed on Jun. 6, 2014. The entirety of this priority provisional patent application is incorporated by reference herein.

### BACKGROUND

In seismic exploration, spectral decomposition refers to any method that produces a continuous time-frequency analysis of a seismic trace. Thus, a frequency spectrum is output for each time sample of the seismic trace. Spectral decomposition has been used for a variety of applications including layer thickness determination, stratigraphic visualization, and direct hydrocarbon detection.

Spectral decomposition is a non-unique process, and thus a single seismic trace may produce various time-frequency analyses. There are a variety of spectral decomposition methods including the short-window Fourier Transform (SWFT), discrete Fourier Transform (DFT), maximum entropy method (MEM), continuous wavelet transform (CWT), and matching pursuit decomposition (MPD). Each method has advantages and disadvantages, and may be suited for different applications.

The DFT and MEM methods involve explicit use of windows, and the nature of the windowing may affect the temporal and spectral resolution of the output. In general, the DFT method is preferred for evaluating the spectral characteristics of long windows containing many reflection events, with the spectra generally dominated by the spacing between events. The MEM method is often difficult to parameterize and may produce unstable results.

The SWFT method uses a long wavelet. The length may be given through the window size for the Fourier Transform and, hence, with a narrow amplitude frequency spectrum and poor vertical resolution. The CWT uses a short wavelet, typically of a Morlet/Gabor shape. The Morlet/Gabor wavelet is essentially an infinite cosine wave, of a given frequency, multiplied with a Gaussian windowing operator of a given wavelet length (i.e., the “scale” parameter). The frequency of the carrier wavelet is defined by this scale, ensuring a similar shape of the wavelet across octave ranges. Due to this, relatively short wavelet length temporal resolution may be high, but poorer resolution may be found in the spectral domain.

### SUMMARY

A method for decomposing a signal is disclosed. The method includes receiving sampled data. A wavelet is built using the sampled data. The wavelet includes a plurality of samples. The wavelet includes a number of oscillations per sampling unit, and a length of the wavelet corresponds to the number of oscillations. The wavelet is time-shifted. The wavelet is scaled after time-shifting such that the samples proximate to one or both ends of the wavelet decay toward zero. The wavelet is also scaled such that an amplitude at a peak frequency of the wavelet, when transformed into a Fourier domain, is substantially unity.

The method may also include varying the number of oscillations per sampling unit.

A channel may be recorded in the sampled data, and building the wavelet may include building the wavelet at least partially based upon the channel. The method may also include removing a negative correlation of a trace with the wavelet, and the trace may include the sampled data recorded for the channel. The negative correlation is removed by setting values for the samples to zero.

The method may also include distributing a positive correlation of the trace with the wavelet over a window length that is a fraction of a wavelength of the wavelet at a center frequency of the wavelet. Distributing the positive correlation of the trace with the wavelet includes applying a filter that distributes energy of the positive correlations over the window length. The filter may be selected from the group consisting of a max filter, a median filter, a root mean square filter, a mean filter, and an envelope filter.

The method may also include convolving the wavelet with the sampled data.

The method may also include drilling a wellbore into a subterranean formation in response to the wavelet indicating a likelihood of hydrocarbons in the subterranean formation.

A computing system is also disclosed. The computing system includes a processor and a memory system including a non-transitory computer-readable medium storing instructions that, when executed by the processor, cause the computing system to perform operations. The operations include receiving seismic data. A wavelet is built using the seismic data. The wavelet includes a plurality of samples. The wavelet includes a number of oscillations per sampling unit, and a length of the wavelet corresponds to the number of oscillations. The wavelet is time-shifted. The wavelet is scaled after time-shifting such that the samples proximate to one or both ends of the wavelet decay toward zero. The wavelet is also scaled such that an amplitude at a peak frequency of the wavelet, when transformed into a Fourier domain, is substantially unity.

A non-transitory computer-readable medium is also disclosed. The medium stores instructions that, when executed by at least one processor of a computing system, cause the computing system to perform operations. The operations include receiving seismic data. A wavelet is built using the seismic data. The wavelet includes a plurality of samples. The wavelet includes a number of oscillations per sampling unit, and a length of the wavelet corresponds to the number of oscillations. The wavelet is time-shifted. The wavelet is scaled after time-shifting such that the samples proximate to one or both ends of the wavelet decay toward zero. The wavelet is also scaled such that an amplitude at a peak frequency of the wavelet, when transformed into a Fourier domain, is substantially unity.

The foregoing summary is presented merely to introduce some of the aspects of the disclosure, which are described in greater detail below. Accordingly, the present summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a flowchart for a method for decomposing a (e.g., seismic) signal, according to an embodiment.

FIG. 2 illustrates a seismic image showing a sedimentary channel, according to an embodiment.

FIG. 3 illustrates a wavelet with an oscillating shape, according to an embodiment.

FIG. 4 illustrates a family of wavelets including the wavelet shown in FIG. 3, according to an embodiment.

FIG. 5 illustrates a window function that may be applied to the wavelet shown in FIG. 3, according to an embodiment.

FIG. 6 illustrates a family of wavelets with a phase of zero degrees, according to an embodiment.

FIG. 7 illustrates a family of wavelets with two cycles and a 90 degree phase shift, according to an embodiment.

FIG. 8 illustrates the wavelet shown in FIG. 3 after the wavelet has been scaled, according to an embodiment.

FIG. 9 illustrates a family of wavelet shapes resulting from varying a cycle count, according to an embodiment.

FIG. 10 illustrates a plot of time versus phase shift for the family of wavelets, according to an embodiment.

FIGS. 11-1, 11-2, and 11-3 illustrate enlarged views of the seismic image of FIG. 2, according to an embodiment. In particular, FIG. 11-1 illustrates the unmodified, enlarged view; FIG. 11-2 illustrates the seismic image with the correlation between the traces in the left image with a wavelet of a 14 Hz center frequency, +90 degree phase rotation, and one cycle of the carrier signal; and FIG. 11-3 illustrates the seismic image with the negative correlations removed.

FIGS. 12-1, 12-2, and 12-3 illustrate, respectively, the seismic input, the positive part of the correlation function, and the maximum filtering of the correlation function, according to an embodiment.

FIG. 13-1 illustrates a time-slice through a maximum-filtered result, according to an embodiment.

FIG. 13-2 illustrates a similar time-slice, but with the filter having different parameters, according to an embodiment.

FIGS. 14-1, 14-2, and 14-3 illustrate, respectively, the input seismic data, a band-pass result for the 14 Hz wavelet, and a result with the same 14 Hz input, but with four oscillations, according to an embodiment.

FIGS. 15-1, 15-2, and 15-3 illustrate, respectively, the seismic input, the result using an embodiment of the method of the present disclosure, and a result using an SWFT method, according to an embodiment.

FIGS. 16-1, 16-2, and 16-3 illustrate similar views as FIGS. 15-1, 15-2, and 15-3, respectively, but shown along a time-slice intersection, according to an embodiment.

FIGS. 17-1, 17-2, and 17-3 illustrate, respectively, another seismic input data, a view with a calculated 10 Hz response, and a view with a calculated 33 Hz response, according to an embodiment.

FIGS. 18-1, 18-2, and 18-3 illustrate views similar to FIGS. 17-1, 17-2, and 17-3, respectively, but with the method of the present disclosure being supplied with different parameters, according to an embodiment.

FIGS. 19-1, 19-2, and 19-3 also illustrate views similar to FIGS. 17-1, 17-2, and 17-3, respectively, but using an SWFT method, according to an embodiment.

FIGS. 20-1, 20-2, and 20-3 again illustrate views similar to FIGS. 17-1, 17-2, and 17-3, respectively, but with a maximum filter set to use a certain window length, according to an embodiment.

FIGS. 21-1, 21-2, and 21-3 again illustrate views similar to FIGS. 17-1, 17-2, and 17-3, respectively, but with different parameters used for the method, according to an embodiment.

FIG. 22 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

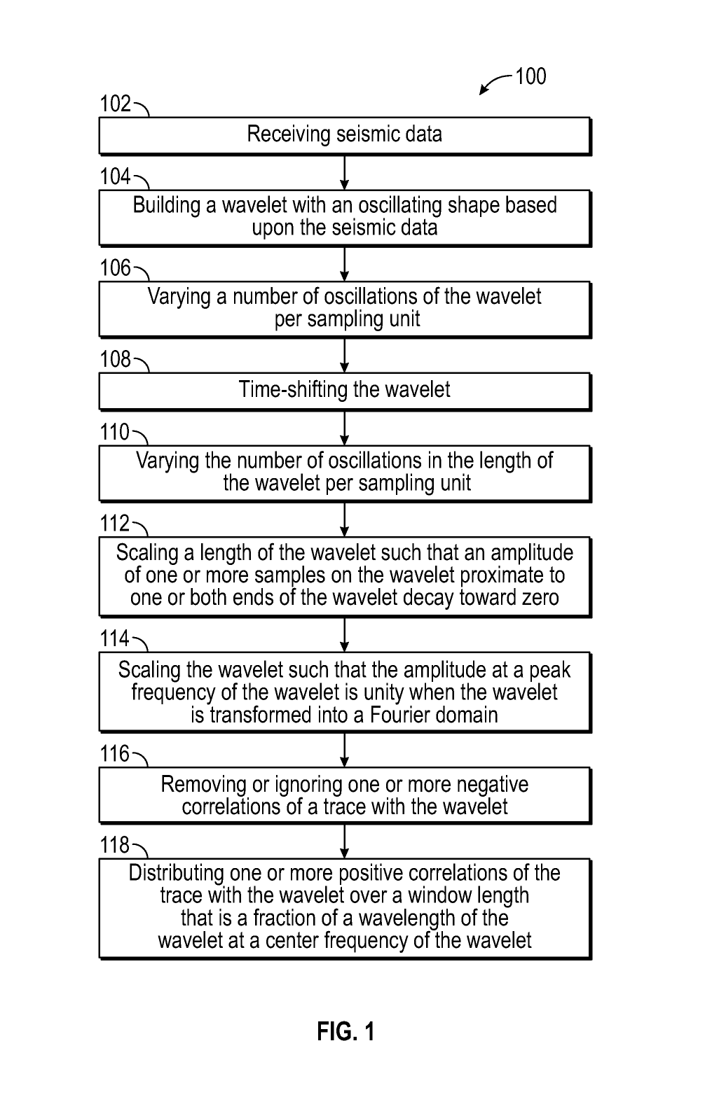

FIG. 1 illustrates a flowchart of a method 100 for decomposing a signal, according to an embodiment. The method 100 may allow a user to generate a wavelet with a flexible design that may be used for the filtering/decomposition of input seismic data. The method 100 may be or include a generalized spectral decomposition method, where the user has enhanced control of vertical resolution and/or frequency resolution. The method 100 may include a flexible and natural parameterization, which may allow the user to design any wavelet shape in the continuum between SWFT and CWT. The use of the “scale” and “number of vanishing moments” parameter in the CWT transform may be avoided, and the wavelet may be defined based on three parameters: (1) frequency, (2) number of cycles, and (3) phase. The resulting raw wavelet may then be scaled such that the correlation of the scaled wavelet with itself (i.e., the auto-correlation) is unity (1.0).

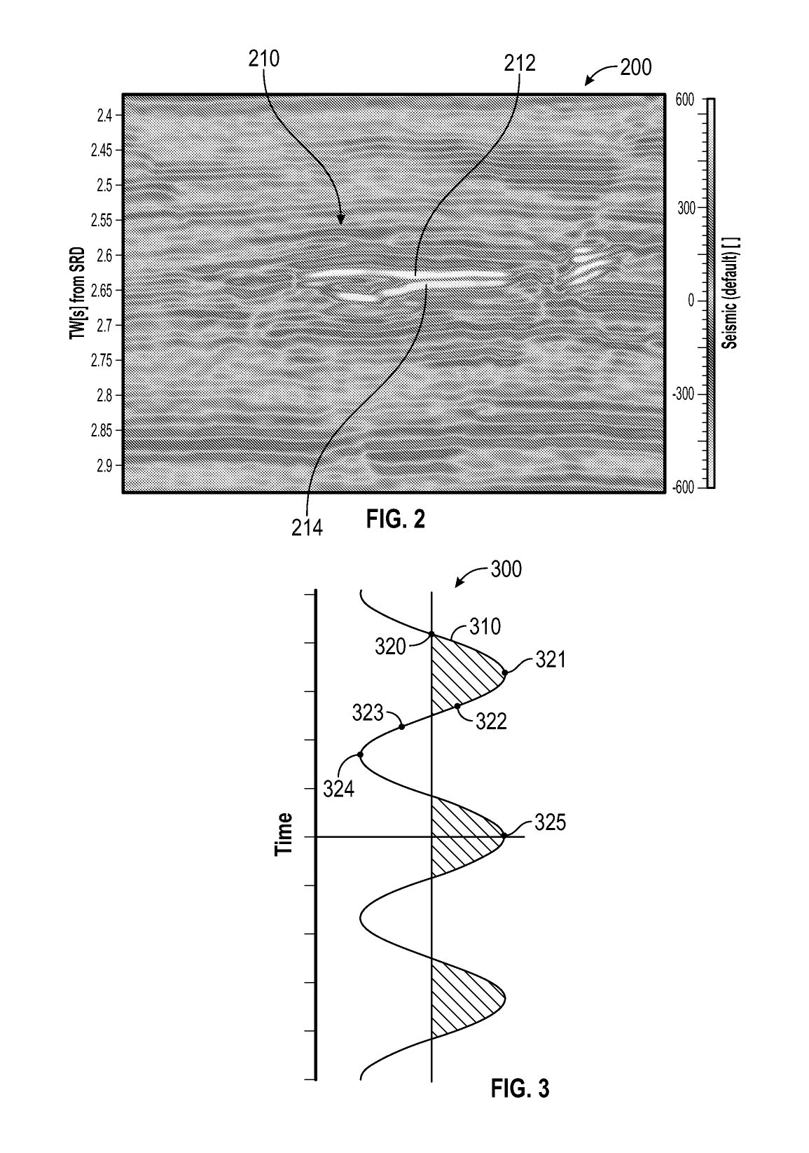

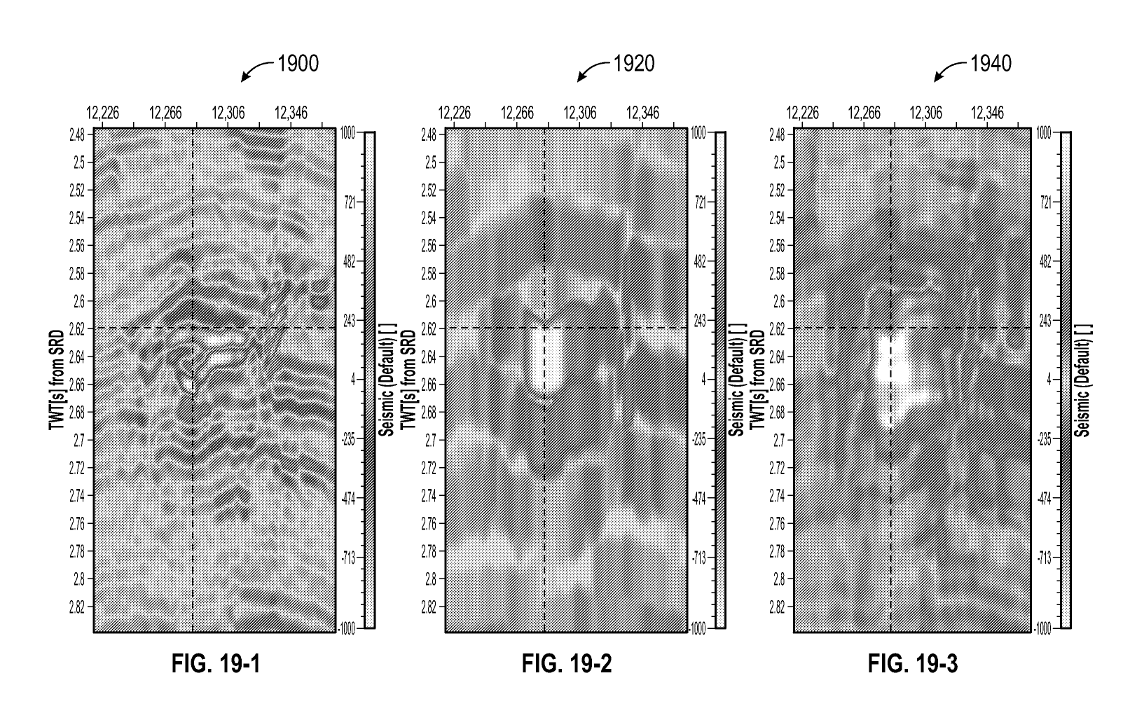

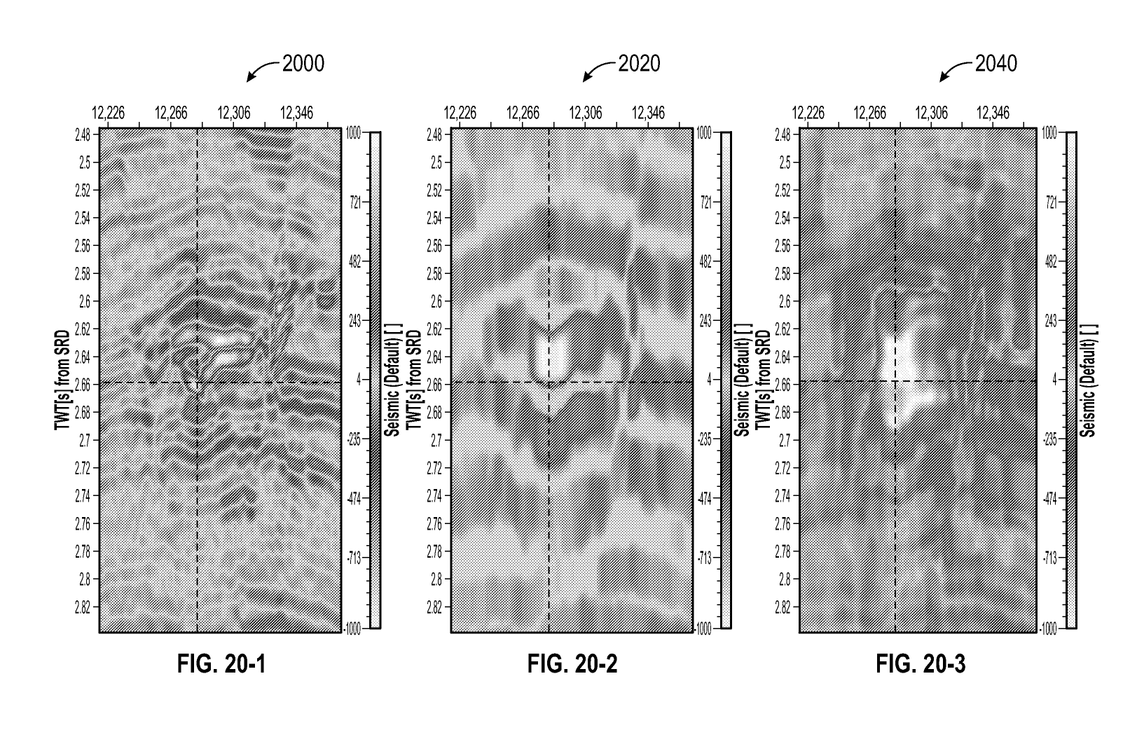

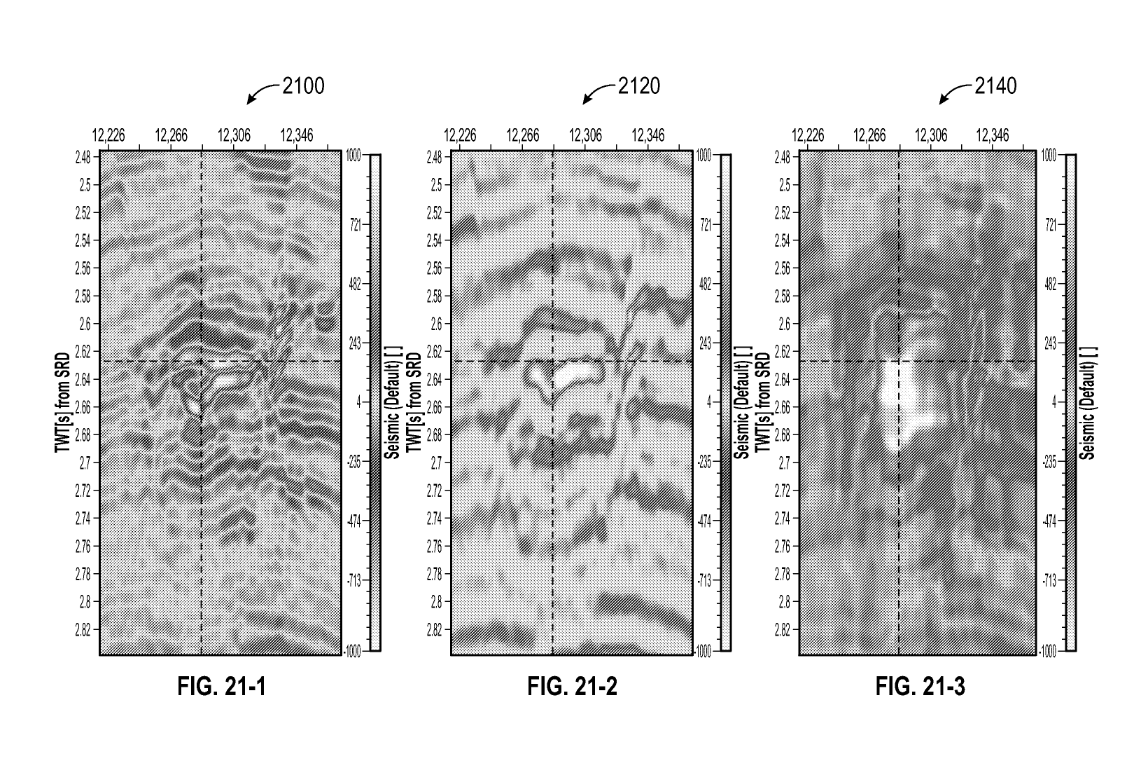

The method 100 is described in part with reference to FIGS. 2-22 and their corresponding descriptions below. Although FIGS. 2-22 and their corresponding descriptions reference a seismic signal, it will be appreciated that in other embodiments, the method 100 may also be used for other types of signals such as medical imaging signals, satellite imaging signals, radar signals, and the like. The method 100 may begin by receiving seismic data, as at 102. For example, a sound vibration generated by a source may reflect off horizons in the subterranean formation. A set of sound vibrations is received by one or more sensors, such as geophone-receivers, situated on the earth's surface. The data received may be provided as input data to a computer, and responsive to the input data, the computer may generate seismic data output. This seismic data output may be stored, transmitted or further processed as desired, for example, by data reduction.

One or more channels may be recorded in the seismic data. As used herein, a “channel” refers to a substantially linear depression through which water and sediment may flow and into which sediment may be deposited in distinctive (e.g., elongated) bodies.

FIG. 2 illustrates an image 200 of seismic data including a sedimentary channel 210. One illustrative use for spectral decomposition may be channel detection. The channel 210 may have one or more strong reflectors 212 defining the top of the channel 210, and one or more trailing reflectors 214 with an opposite polarity, but similar amplitude (e.g., a sand channel surrounded by shale scenario). The polarity of the top and bottom reflectors 212, 214 may be known. This is given by the polarity standard for the seismic data at hand. For example, the polarity standard may be positive on top and negative on the bottom, although the opposite polarity may also exist. The distance in traveltime between the top and bottom reflectors 212, 214 (also referred to as interfaces) defines the “resonancy” frequency for the channel 210.

In the example of FIG. 2, the distance between top and bottom reflectors 212, 214 is about 35 milliseconds, and the resonancy frequency for the channel 210 embedded between the two reflectors 212, 214 is 1000/2 *35 ms=14 Hz. This means that the wavelet shape that correlates best with this channel body may be a wavelet kernel with central frequency of 14 Hz, and a phase of +90 degrees. As such, the method 100 may include building or constructing a wavelet (i.e., a time-series of sample values) in the shape of an array with an oscillating shape based upon the seismic data, as at 104 in FIG. 1. For example, the shape of the wavelet may be similar or equal to a cosine wave. In at least one embodiment, the wavelet may be built based at least partially upon the channel 210 in the seismic data.

FIG. 3 illustrates an image 300 of a wavelet 310 with an oscillating shape, according to an embodiment. The wavelet 310 may include a plurality of samples 320-325. As used herein, a “sample” or “sample value” refers to the amplitude of the wavelet 310. The x-axis represents time. The time may be measured in milliseconds or seconds. The y-axis may represent depth, distance, time, pixel, voxel, voter, etc. When the y-axis represents distance, the units may be meters, kilometers, light years, etc.

The method 100 may include varying a number of oscillations (i.e., frequency) of the wavelet per sampling unit, as at 106 in FIG. 1. As used herein, a “sampling unit” refers to a unit of time (e.g., 1 second) for time-domain data. The number of oscillations for the wavelet 310 may influence how precisely channels (e.g., channel 210) of that particular thickness may be mapped. As shown, the wavelet 310 is shown including three oscillations. Decreasing the number of oscillations may improve vertical localization (e.g., due to the short wavelet), but may not allow discrimination between different channel thicknesses. Increasing the number of oscillations may better isolate layers with the desired thickness, but may result in diminished lateral resolution (e.g., due to the longer wavelet and, hence, longer “zone of influence”).

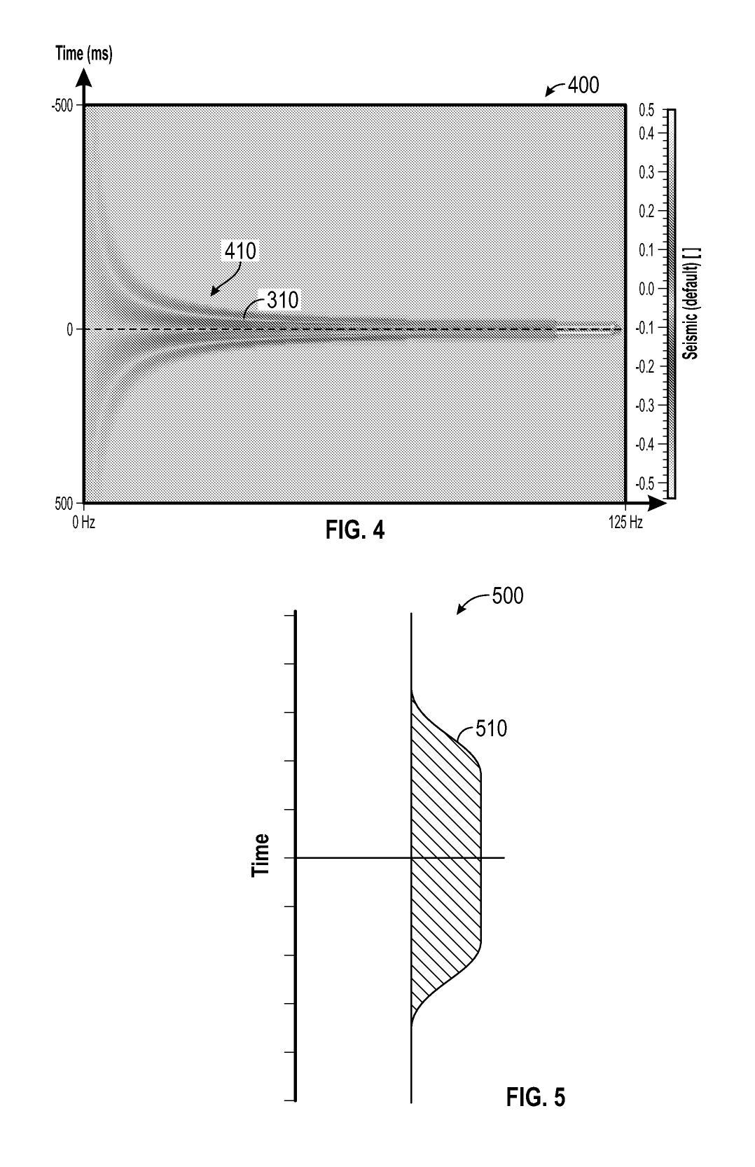

FIG. 4 illustrates an image 400 showing a family of wavelets 410 including the wavelet 310 shown in FIG. 3. FIGS. 3 and 4 appear different because FIG. 3 is plotted in a “wiggle-plot” style while FIG. 4 is plotted in “variable density” style, where grey-scale is used to indicate sample amplitude. In addition, FIG. 3 shows a single wavelet 310 with three oscillations and a 0 degree phase shift, while FIG. 4 shows a plurality of wavelets 410 with two oscillations and a 90 degree phase shift. In FIG. 4, the horizontal axis separates the wavelets, and individual wavelets are rendered vertically. The family of wavelets 410 has a center frequency in the range from 1 to 125 Hz. The wavelets 410 are shown with a −90 degree phase shift and a length equal to two oscillations. As can be seen, the wavelets 410 are tapered. There are many suitable ways to taper the wavelets 410. For example, one way to taper the wavelets 410 is to apply a Hanning window function. For example, FIG. 5 illustrates an image 500 of a window function 510 that may be applied to the wavelet 310. The oscillations may not be tapered. For example, the taper function may take effect at the start and the end of the center cycle.

In at least one embodiment, the method 100 may include time-shifting one or more of the wavelets 410 (e.g., wavelet 310) to detect a spectral component with a peak located at a temporal offset (e.g., a time shift) from the analysis sample location, as at 108 in FIG. 1. The amount of the time shift may be determined by the user. The time shift may occur before or after the number of oscillations is varied. The shift may be specified as a phase shift (e.g., with the units being degrees or radians).

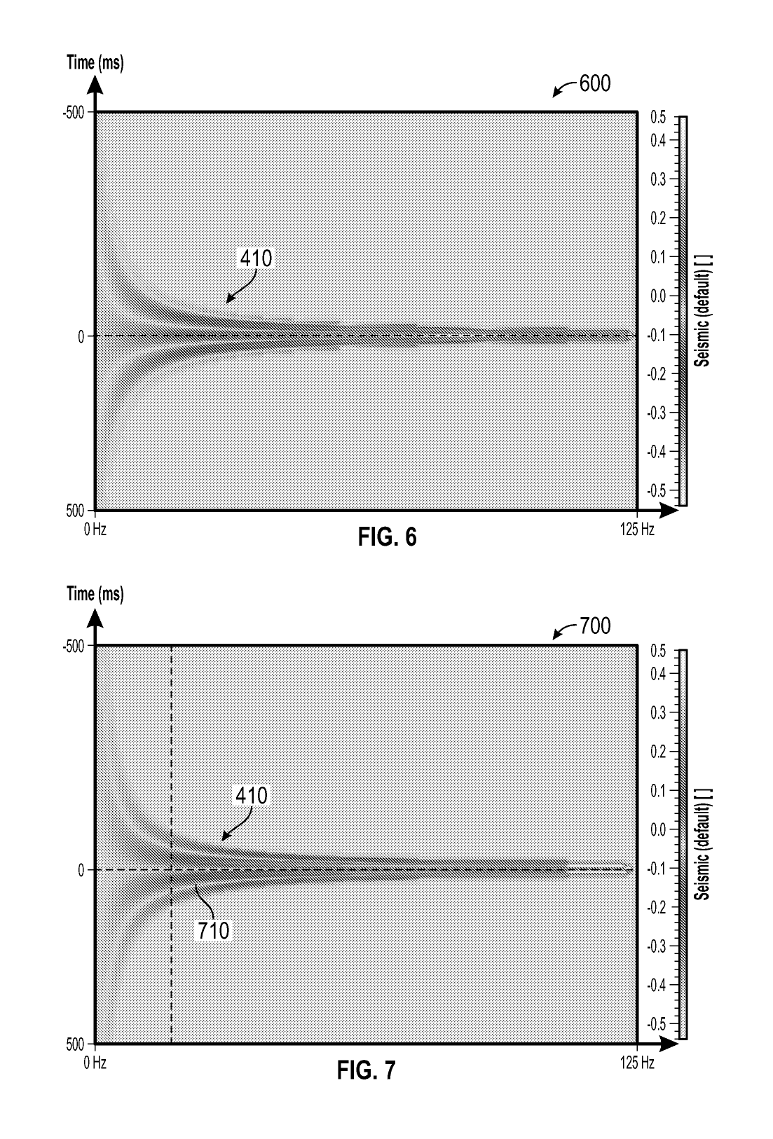

FIG. 6 illustrates an image 600 showing the family of wavelets 410 shown in FIG. 4, but with phase=0 degrees, and FIG. 7 illustrates an image 700 showing the family of wavelets 410 shown in FIG. 4 having two cycles, but this time with a +90 degree phase shift. The crosshair cursor 710 points to the wavelet 310 (e.g., 14 Hz), which has a 35 millisecond distance between peak and trough, which may be used to detect the channel (e.g., channel 210 from FIG. 2) through convolution with the seismic traces. As used herein, a “seismic trace” refers to the seismic data recorded for a channel (e.g., channel 210). The seismic trace represents the response of the elastic wavefield to velocity and density contrasts across interfaces of layers of rock or sediments as energy travels from a source through the subsurface to a receiver.

The method 100 may also include varying the number of oscillations in the length of the wavelet 310, as at 110 in FIG. 1. The number of oscillations of the wavelet 310 may be varied by the user before or after the wavelet 310 is time-shifted.

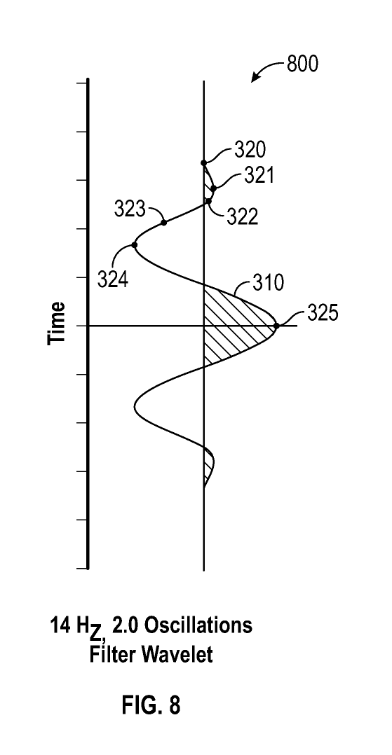

FIG. 8 illustrates an image 800 of the wavelet 310 shown in FIG. 3 after the wavelet 310 has been tapered (by the window function 510) and scaled, according to an embodiment. The method 100 may also include scaling the length of the wavelet 310 such that the amplitude of the samples proximate to the center (e.g., sample 525) remain substantially unaltered, and the amplitude of the samples proximate one or both ends of the wavelet 310 (e.g., samples 320-322) decay towards zero, as at 112 in FIG. 1. The “center” refers to the sample on the wavelet 310 where time=0. The method 100 may also include scaling the wavelet 310 such that an amplitude at a peak frequency of the wavelet 310 is substantially unity (i.e., 1.0) when the wavelet 310 is transformed into a Fourier domain, as at 114 in FIG. 1.

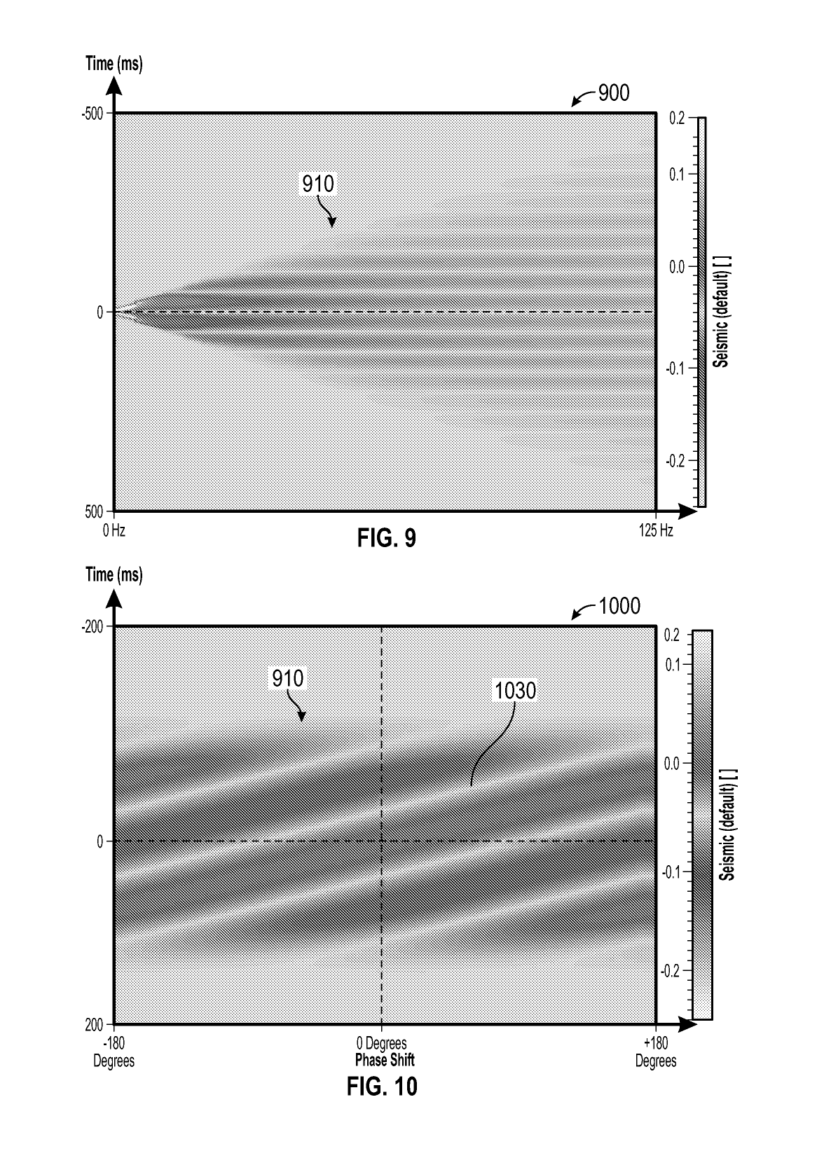

FIG. 9 illustrates an image 900 showing the various shapes of wavelets 910 generated when the cycle count is varied from 0.0 to 10.0 cycles, but the center frequency remains constant at 10 Hz and the phase remains constant at +90 degrees. As will be appreciated, the number of cycles/oscillations may not be an integer value. Further, the wavelets 910 in this example may tapered with a Hanning window function, which may not taper the center cycle.

FIG. 10 illustrates an image 1000 showing the wavelets 910 shown in FIG. 9 with the phase parameter varied. The wavelet varies in shape when the phase is varies from −180 degrees (on the left in FIGS. 10) to +180 degrees (on the right in FIG. 10). The cross-hair cursor 1030 identifies the location of the 0 degree phase wavelet.

The wavelet-shaping parameters may not be integer numbers. For example, fractional center frequencies, fractional phase shifts, and fractional number of oscillations/cycles may be employed or otherwise exist. Any of these values may be any real-valued number. This may also apply to max-filter window length parameters, as described below.

In some embodiments, the method 100 may then proceed to improving the vertical definition of the frequency response. The method 100 may accomplish this by removing or ignoring one or more negative correlations of the trace with the wavelet, as at 116 in FIG. 1. This may facilitate discriminating between wanted and unwanted features in the seismic trace, as described in more detail below.

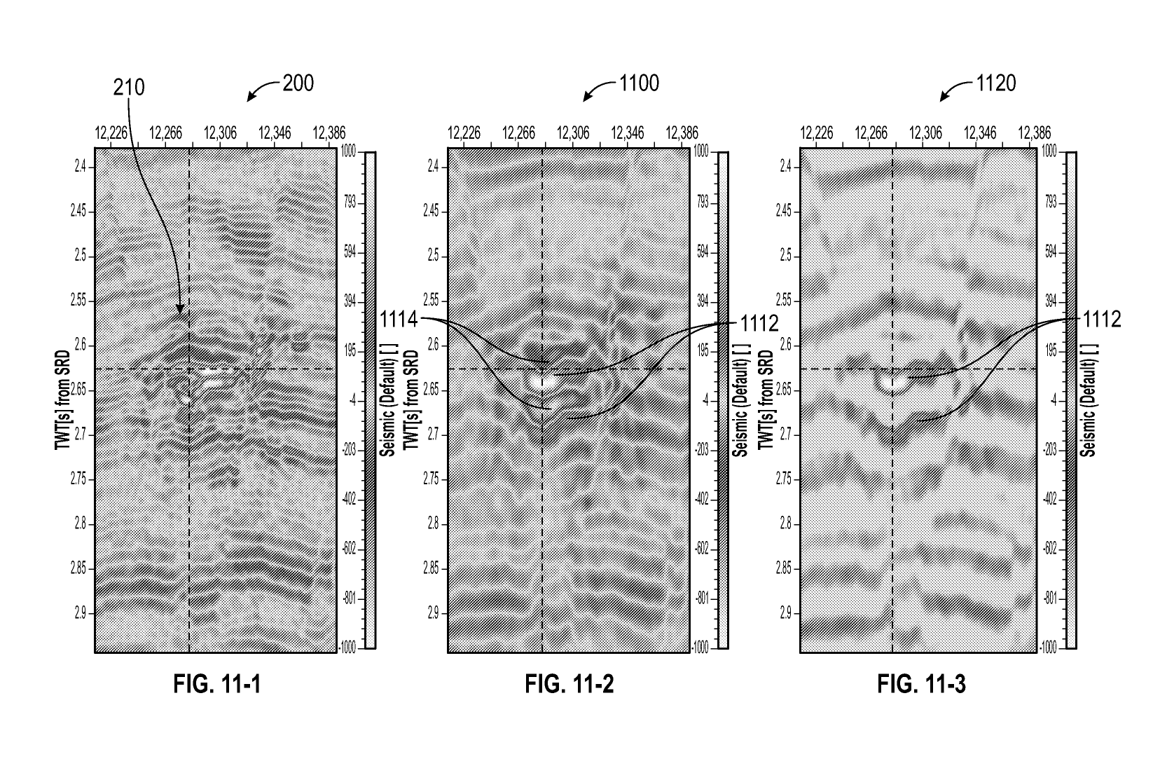

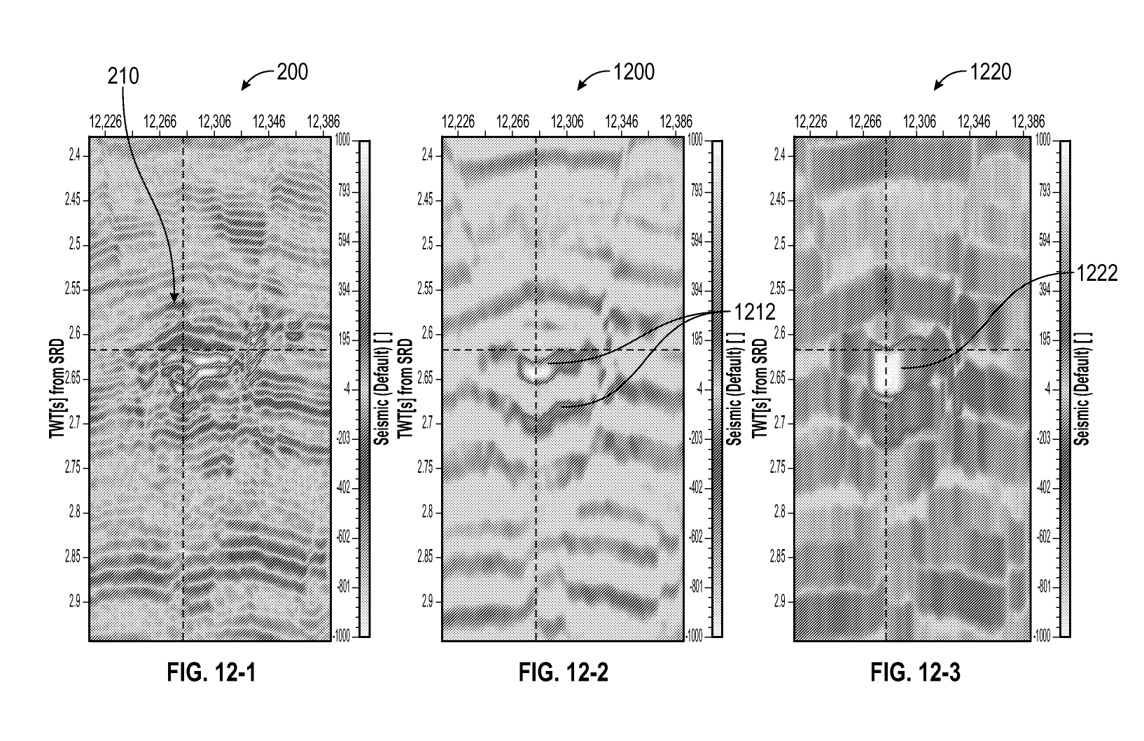

For example, FIG. 11-1 illustrates the image 200 shown in FIG. 2 including the channel 210, according to an embodiment. FIG. 11-2 illustrates an image 1100 showing the correlations (e.g., positive correlations 1112 and negative correlations 1114) between the traces in FIG. 11-1 with a wavelet with a 14 Hz center frequency, +90 degrees phase rotation, and one cycle of this 14 Hz carrier signal. As shown in FIG. 11-2, the channel 1110 may be well-defined with a positive correlation value 1112. However, there may also be a negative correlation 1114 immediately below. This may be caused by interference between the base of the channel 210 and a third reflector approximately 35 ms below the channel base.

This negative-positive response may not be of interest in this case, which may include searching for positive-negative reflector pairs. Thus, it may be useful to remove or ignore the negative correlations 1114, by setting those samples to zero. The result of ignoring the negative correlations 1114 is shown in the image 1120 in FIG. 11-3. As can be appreciated, the channel section 1110 is well defined, and now is in a format that may be suitable for input to a “geobody” volume extraction.

Further, the positive part/lobe of the correlation function 1112 may be wide, and may almost cover the whole channel zone defined by the top and bottom reflectors. The thickness of the positive part/lobe of the correlation function 1112 may be determined based at least partially on the chosen center frequency, and the chosen number of oscillations, and thus may or may not span the whole channel window.

In some embodiments, the method 100 may proceed to distributing one or more positive correlations of the trace with the wavelet over a window length that is a fraction of a wavelength of the wavelet at a center frequency of the wavelet, as at 118 in FIG. 1. In at least one embodiment, this may be accomplished by applying a max-function to the correlation function. The max-function may be applied to more than the positive part of the correlation function 1112, as the max-function may not honor negative correlation values 1114. As the term is used herein, “max-function” (or “max-filter”) refers to a function which for each sample returns the maximum value within a user-defined radius. In one example, a window-length for the max-function may be equal to half the wavelength of the wavelet center frequency; however, any window length greater than or equal to 0.0 milliseconds may be used, in some embodiments, for this window size. However, the window-length for the max-function may be equal to any fraction of the wavelength of the wavelet center frequency. As used in this context, a “fraction” may be less than or greater than 1.0. For example, the fraction may be greater than 1.0 to highlight the largest correlation value within a long time interval.

FIGS. 12-1, 12-2, and 12-3 illustrate images of the max-filter step for the channel 210 shown in FIG. 2, with window length=0.5*wavelength=35 milliseconds. Specifically, FIG. 12-1 illustrates the image 200 shown in FIG. 2, which may include the channel 210. FIG. 12-2 illustrates an image 1200 showing a positive part of a correlation function 1212. FIG. 12-3 illustrates an image 1220 showing a max-filtering of a correlation function 1222, with max-filter length=1000/2*Fcenter=35 ms. As can be appreciated, the correlation response after max-filtering has almost the same thickness as the channel thickness that is being extracted and enhanced. Moreover, the max-response may be located in the center between the top and the base of the channel 210.

In addition to the max-filter, there are other filters that may also be employed for the same or generally similar purposes. For example, median-filtering of the positive part 1212, RMS of the positive part 1212, mean-filtering of the positive part 1212, and any other vertical filter (e.g., envelope filter) which may distribute the energy of the positive part of the correlation function 1212 over the desired window size (e.g., which by default may be 0.5×wavelength).

The max-window size may be substantially larger than the wavelength of the central frequency, as this may give the user the benefit of additional “depth of vision” when the result is displayed in time-slice mode. FIGS. 13-1 and 13-2 provide an illustrative example.

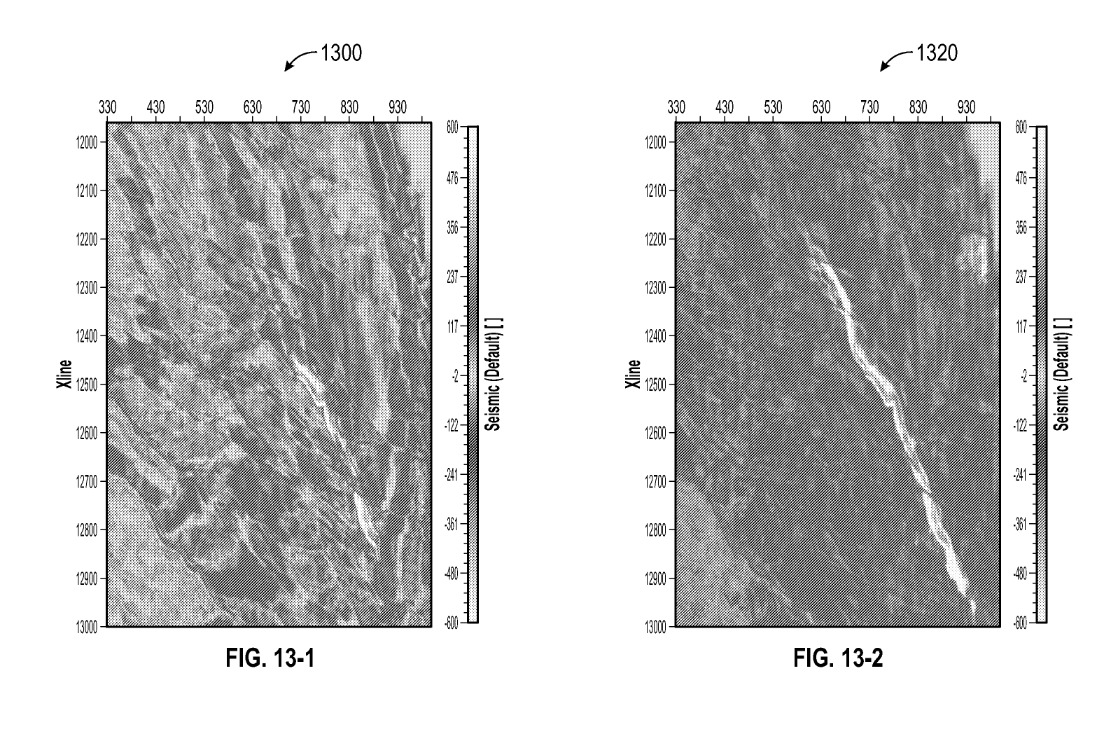

In particular, FIG. 13-1 illustrates an image 1300 showing a time-slice through the max-filtered result, with window size equal to half the wavelength of the central frequency. The time-slice intersects parts of the channel. FIG. 13-2 illustrates an image 1320 showing a similar result with a max-filter window of 2.5 times the wavelength (i.e. 2.5×70 milliseconds=˜170 milliseconds window size). The spatial location of the channel throughout the whole area may be seen, as this view is essentially looking deeper down into the strata. The exact vertical location of the channel may be smeared through this process because the channel may be at any vertical location within this fairly wide vertical window.

Three or more volumes with the same input wavelet may then be calculated, but with three different max-window sizes. These different volumes may have different levels of “depth vision,” depending on their window size. Three of these volumes may then be co-rendered simultaneously in (e.g., a Red-Green-Blue (RGB) color-setup). The intensity of the three different colors may then represent the amplitude for the three different “depths of vision.” If the three colors lit simultaneously, the channel/feature may be close to the time-slice. If the color with the largest “depth of vision” (i.e., largest max-window) lights up while the other colors do not, then the object may be far away from the slice. The max-filter length constant for the three cubes may then be input to the RGB blending, but with the samples shifted substantially down in the one cube (e.g., with a shift proportional to the max-window length), and the samples shifted substantially up (e.g., with a similar amount of shift) in the second cube. For example, the values shifted from above may be assigned to the Red channel, the un-shifted volume to the Green channel, and the values shifted from below to the Blue channel. When then co-rendered in the RGB scale, it may be determined whether the channel/feature/object is close to the time-slice intersection, or if it is above or below the time-slice intersection. This is not restricted to RGB blending. For example, other similar color mixing schemes (e.g., Hue-Saturation-Intensity blending, aka HSV) may also be used.

In some embodiments, the method 100 may include performing a convolution of the trace and the wavelet discussed above (e.g., instead of performing a correlation). This may be useful to extract and highlight the part of the seismic data that triggers a positive response in the correlation. In essence, this becomes a band-pass filter, where the subset of the signal, which correlates with the chosen wavelet, is passed on to the output, and the other frequencies are attenuated. In this case, the wavelet may use a different normalization. The normalization may be conducted in the frequency domain. That is, the raw wavelet may be converted to the frequency domain through a Fourier transform, the amplitude spectrum calculated, and the maximum amplitude Amax in the amplitude spectrum selected. The scaling factor s may then be set to 1/Amax. In another embodiment, the amplitude of the specified center frequency may be selected directly. This scaling factor may ensure that the center-frequency part of the signal is not affected by the band-pass filter, while one or more other frequencies are attenuated.

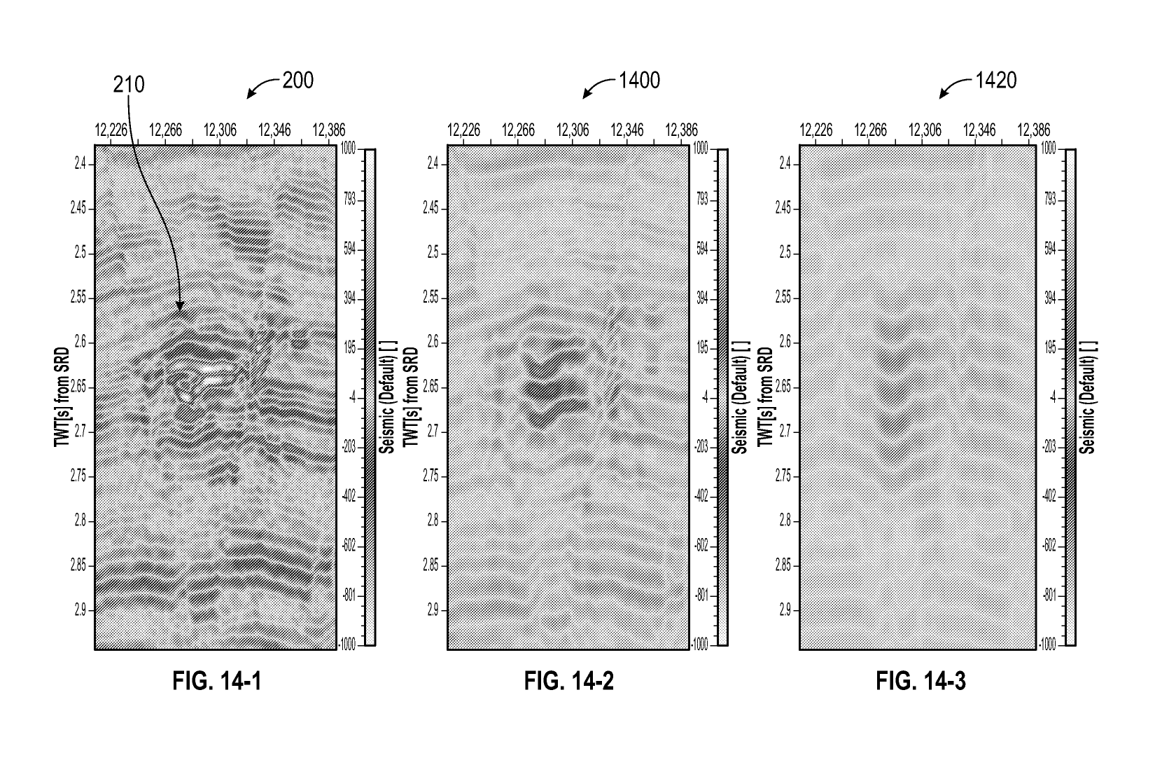

FIG. 14-1 illustrates the image 200 shown in FIG. 2 including the channel 210. FIG. 14-2 illustrates an image 1400 showing the band-pass result for the 14 Hz, wavelet, and one full oscillation, but with the phase set to zero, in order to avoid phase rotation of the input seismic spectral component. FIG. 14-3 illustrates an image 1420 showing the corresponding result with the same 14 Hz central frequency, but with four oscillations instead of one. The amplitude spectrum of the result may become more and more narrow as the wavelet length is increased (i.e., more cycles) and, hence, less energy is passed through the band-pass filter.

In at least one embodiment, the method 100 may also include performing a finite Fourier transform on the wavelet. The Fourier transform/decomposition, for a given frequency, is by definition just the correlation between the input signal and two infinite cosine sequences of the desired frequency, where the first sequence has a 0 degree phase rotation (the real part r), and the second sequence has a +90 degree phase rotation (the imaginary part i).

The amplitude response a of the frequency is:

a=SQRT(r̂2+î2)

and the phase response p of the frequency is:

p=inverse sin (i/a)

A finite Fourier transform may be implemented, which belongs in the family of SWFT spectral decomposition methods, using the wavelets generated above. This time, however, the correlation may be performed twice, and the second correlation may be done using the same wavelet as in the first correlation, but with a 90 degree phase shift applied. The amplitude response and phase response may then be calculated according to the equations listed above.

### Example Results

This section contains some examples of comparisons between results from SWFT and the Generalized Spectral Decomposition (GSD) method, according to an embodiment.

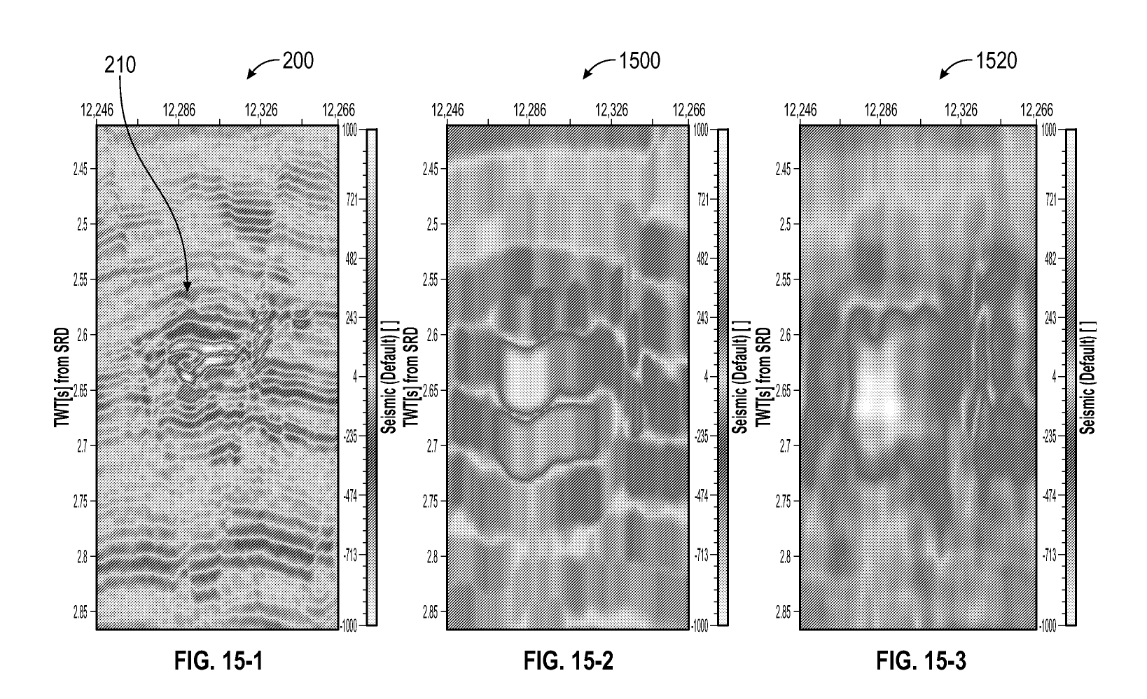

FIG. 15-1 illustrates image 200 shown in in FIG. 2 including the channel 210; FIG. 15-2 illustrates an image 1500 showing the result from an embodiment of the present method 100 (e.g., using 14 Hz corner frequency, +90 degree phase shift, 2 cycles/140 millisecond wavelet length); and FIG. 15-3 illustrates an image 1520 showing the result using the SWFT method (14 Hz center frequency, 128 ms/32 samples window length, the shortest window length practically possible with this method). As may be seen, more well-separated layer responses are generated with the present method 100 (FIG. 15-2), at least partially because the method 100 is parameterized to focus on the presence of a positive-negative interface combination. The SWFT method is unable to discriminate between a positive-negative sequence and a negative-positive sequence, unless the phase spectrum is also included in the analysis.

FIGS. 16-1, 16-2, and 16-3 illustrate images 1600, 1620, 1640 showing the same data as in FIGS. 15-1, 15-2, 15-3, respectively, but displayed along a time-slice intersection. There is somewhat less energy in the GSD approach, when compared to the SWFT result, due to better focusing on the positive-negative interface sequence.

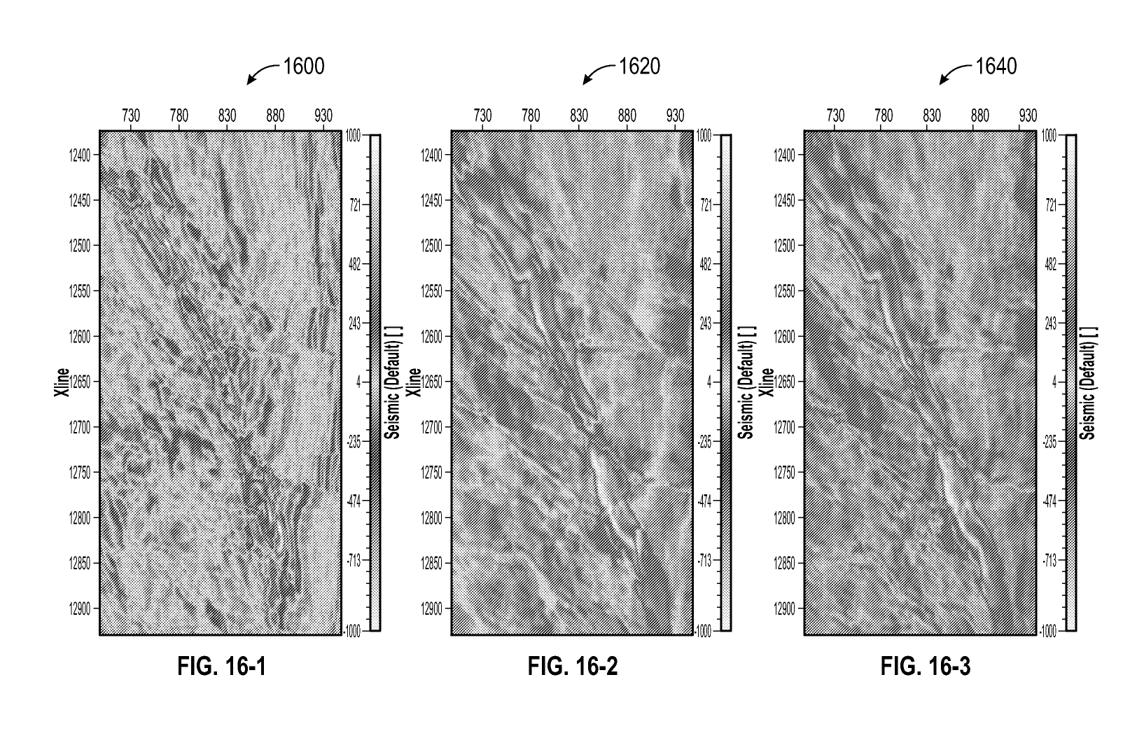

In this example, almost equal window lengths are used for the two experiments, in order to do a fair comparison. Embodiments of the present method 100 (FIG. 16-2) may facilitate moving towards shorter window lengths, on a scale comparable to classic CWT methods, while the SWFT method (FIG. 16-3) is not efficient for window sizes below 32 samples (the next window length further down is a 16 sample window length, if the method is implemented with the classic FFT method).

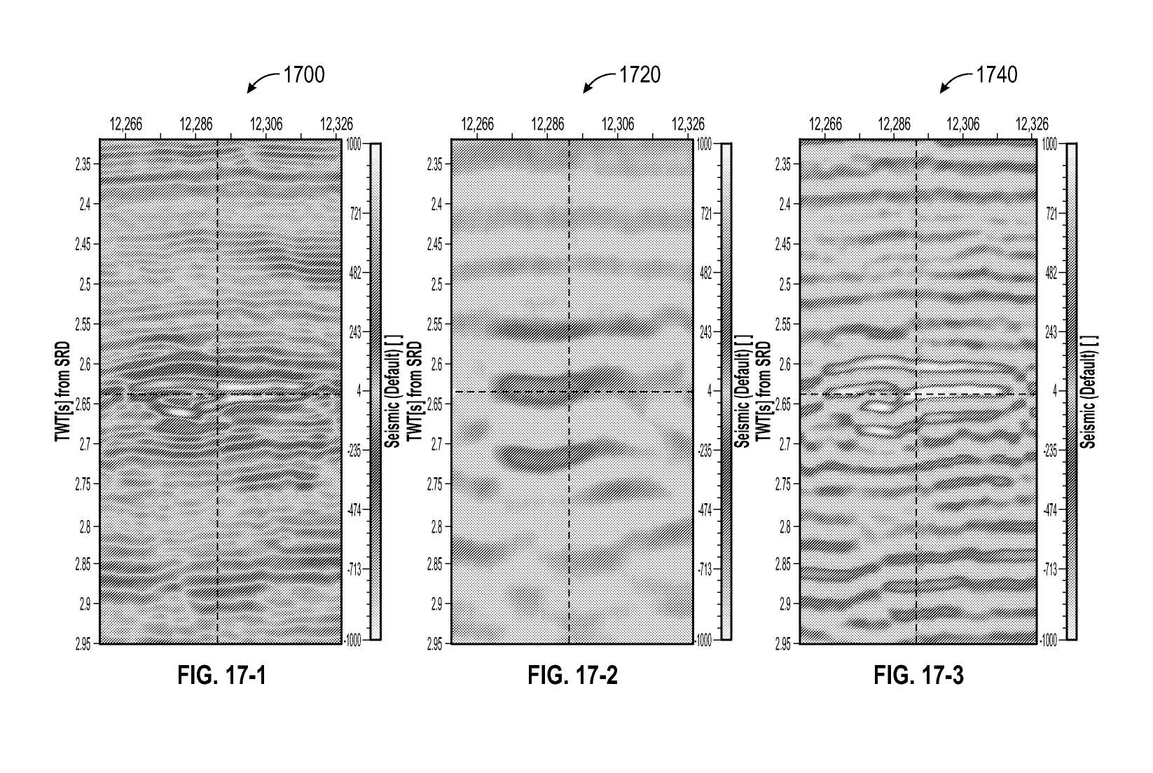

FIGS. 17-1, 17-2, and 17-3 illustrate images 1700, 1720, 1740 showing the channel mainly consisting of a thick central part, but with substantially thinner “wings.” The peak-troff distance for the wings is approximately 15 milli-seconds, implying a resonancy frequency of close to 33 Hz. Calculating the 10 Hz response (in FIG. 17-2) and the 33 Hz response (in FIG. 17-3), both the wings and the thicker central part may be clearly detected. The thick central part may also be isolated in the 10 Hz component, with minimal leaked response from the wings. The same applies for the 33 Hz component, which captures the the thin positive-negative sequences, and fully ignores the thick central part.

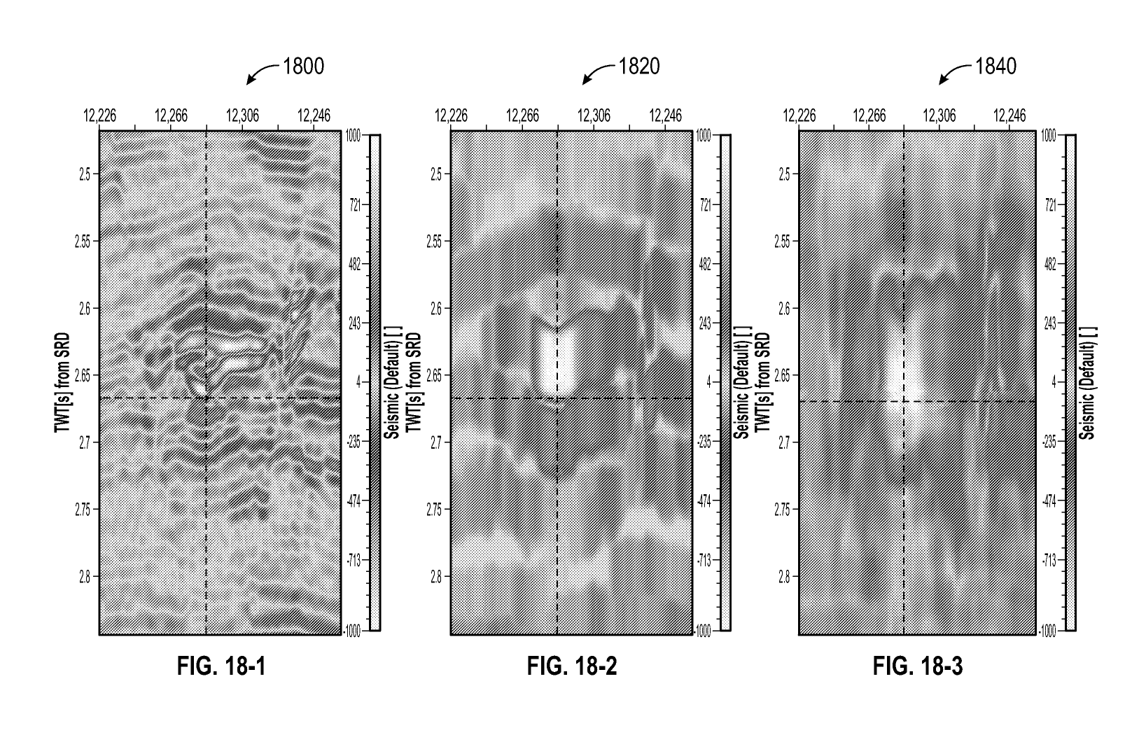

FIGS. 18-1, 18-2, and 18-3 illustrate images 1800, 1820, 1840 showing the same data shown in FIGS. 17-1, 17-2, and 17-3, respectively. However, the GSD method in the FIG. 18-2 this time is run with a 1.0 oscillation/70 millisecond/17 sample window length. As shown, the later lateral resolution in FIG. 18-2 is improved compared to the SWFT result (FIG. 18-3).

FIGS. 19-1, 19-2, and 19-3 illustrate images 1900, 1920, 1940 showing the same data shown in FIGS. 18-1, 18-2, and 18-3, respectively, but with a 70 millisecond/17 sample SWFT method. FIGS. 20-1, 20-2, and 20-3 illustrate images 2000, 2020, 2040 showing yet more views of the same data, but with a max-filter set to use a window length equal to 0.3 times the wavelength (i.e., approx. 20 milli-seconds). Better focusing may be seen on the desired channel body, when compared to the (very-short-windowed) SWFT method.

FIGS. 21-1, 21-2, and 21-3 illustrate images 2100, 2120, 2140 showing more views of the same data, but with the GSD method run with a 0.5 oscillations/35 milliseconds/9 sample window length, and with no applied max filtering. The mapping the channel appears more effective when compared to the short-windowed SWFT method. This very short window length for the GSD method is way below practical wavelet lengths for the CWT method.

The images resulting from the use of the method 100 may provide a better understanding of the subterranean formation. For example, the images may indicate a likelihood of a presence of hydrocarbons in the subterranean formation. As a result, in response to viewing the images, the user may decide whether or not to drill a wellbore in a certain location in search of hydrocarbons.

Attention is now directed to processing procedures, methods, techniques and workflows that are in accordance with some embodiments. Some operations in the processing procedures, methods, techniques and workflows disclosed herein may be combined and/or the order of some operations may be changed.

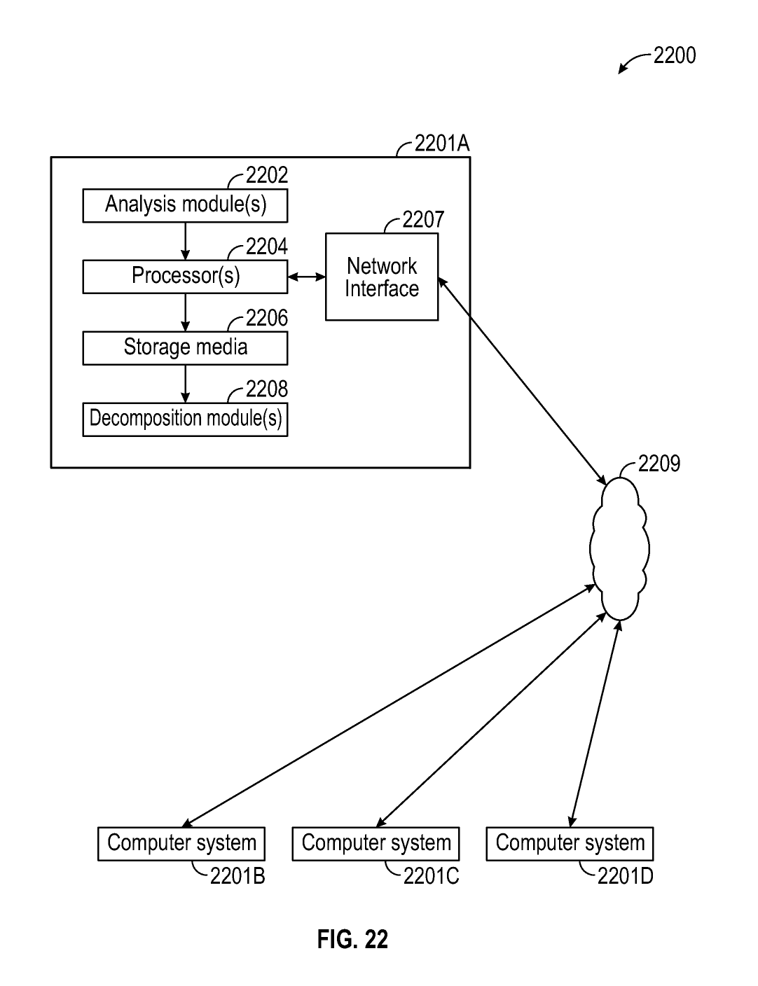

In some embodiments, the methods of the present disclosure may be executed by a computing system. FIG. 22 illustrates an example of such a computing system 2200, in accordance with some embodiments. The computing system 2200 may include a computer or computer system 2201A, which may be an individual computer system 2201A or an arrangement of distributed computer systems. The computer system 2201A includes one or more analysis modules 2202 that are configured to perform various tasks according to some embodiments, such as one or more methods (e.g., method 100) disclosed herein. To perform these various tasks, the analysis module 2202 executes independently, or in coordination with, one or more processors 2204, which is (or are) connected to one or more storage media 2206A. The processor(s) 2204 is (or are) also connected to a network interface 2207 to allow the computer system 2201A to communicate over a data network 2209 with one or more additional computer systems and/or computing systems, such as 2201B, 2201C, and/or 2201D (note that computer systems 2201B, 2201C and/or 2201D may or may not share the same architecture as computer system 2201A, and may be located in different physical locations, e.g., computer systems 2201A and 2201B may be located in a processing facility, while in communication with one or more computer systems such as 2201C and/or 2201D that are located in one or more data centers, and/or located in varying countries on different continents).

A processor can include a microprocessor, microcontroller, processor module or subsystem, programmable integrated circuit, programmable gate array, or another control or computing device.

The storage media 2206 can be implemented as one or more computer-readable or machine-readable storage media. Note that while in the example embodiment of FIG. 22 storage media 2206 is depicted as within computer system 2201A, in some embodiments, storage media 2206 may be distributed within and/or across multiple internal and/or external enclosures of computing system 2201 and/or additional computing systems. Storage media 2206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or in other embodiments, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, the computing system 2200 may include one or more decomposition modules 2208 that may preform at least part of the method 100. It should be appreciated that computing system 2200 is one example of a computing system, and that computing system 2200 may have more or fewer components than shown, may combine additional components not depicted in the example embodiment of FIG. 22, and/or computing system 2200 may have a different configuration or arrangement of the components depicted in FIG. 22. The various components shown in FIG. 22 may be implemented in hardware, software, or a combination of both hardware and software, including one or more signal processing and/or application specific integrated circuits.

Further, aspects of the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain the principals of the invention and its practical applications, to thereby enable others skilled in the art to utilize the invention and various embodiments with various modifications as are suited to the particular use contemplated. Additional information supporting the disclosure is contained in the appendix attached hereto.

What is claimed is:

1. A method for decomposing a signal, comprising:
receiving sampled data;
building a wavelet comprising a plurality of samples using the sampled data, wherein the wavelet includes a number of oscillations per sampling unit, and wherein a length of the wavelet corresponds to the number of oscillations;
time-shifting the wavelet;
scaling the wavelet after time-shifting the wavelet such that the samples proximate to one or both ends of the wavelet decay toward zero; and
scaling the wavelet such that an amplitude at a peak frequency of the wavelet, when transformed into a Fourier domain, is substantially unity.

2. The method of claim 1, further comprising varying the number of oscillations per sampling unit.

3. The method of claim 1, wherein a channel is recorded in the sampled data, and wherein building the wavelet further comprises building the wavelet at least partially based upon the channel.

4. The method of claim 2, further comprising removing one or more negative correlations of a trace with the wavelet, wherein the trace comprises the sampled data recorded for the channel.

5. The method of claim 4, wherein the one or more negative correlations are removed by setting values for one or more of the samples to zero.

6. The method of claim 4, further comprising distributing one or more positive correlations of the trace with the wavelet over a window length that is a fraction of a wavelength of the wavelet at a center frequency of the wavelet.

7. The method of claim 6, wherein distributing the positive correlations of the trace with the wavelet comprises applying a filter that distributes energy of the positive correlations over the window length.

8. The method of claim 7, wherein the filter is selected from the group consisting of a max filter, a median filter, a root mean square filter, a mean filter, and an envelope filter.

9. The method of claim 1, further comprising convolving the wavelet with the sampled data.

10. The method of claim 1, further comprising drilling a wellbore into a subterranean formation in response to the wavelet indicating a likelihood of hydrocarbons in the subterranean formation.

11. A computing system comprising:
one or more processors; and
a memory system comprising one or more non-transitory computer-readable media storing instructions that, when executed by at least one of the one or more processors, cause the computing system to perform operations, the operations comprising:
receiving seismic data;
building a wavelet comprising a plurality of samples using the seismic data, wherein the wavelet includes a number of oscillations per sampling unit, and wherein a length of the wavelet corresponds to the number of oscillations;
time-shifting the wavelet;
scaling the wavelet after time-shifting the wavelet such that the samples proximate to one or both ends of the wavelet decay toward zero; and
scaling the wavelet such that an amplitude at a peak frequency of the wavelet, when transformed into a Fourier domain, is substantially unity.

12. The computing system of claim 11, wherein the operations further comprise varying the number of oscillations per sampling unit.

13. The computing system of claim 11, wherein a channel is recorded in the seismic data, and wherein building the wavelet further comprises building the wavelet at least partially based upon the channel.

14. The computing system of claim 13, wherein the operations further comprise removing one or more negative correlations of a trace with the wavelet, wherein the trace comprises the seismic data recorded for the channel.

15. The computing system of claim 14, wherein the one or more negative correlations are removed by setting values for one or more of the samples to zero.

16. The computing system of claim 14, wherein the operations further comprise distributing one or more positive correlations of the trace with the wavelet over a window length that is a fraction of a wavelength of the wavelet at a center frequency of the wavelet.

17. The computing system of claim 16, wherein distributing the positive correlations of the trace with the wavelet comprises applying a filter that distributes energy of the positive correlations over the window length.

18. The computing system of claim 17, wherein the filter is selected from the group consisting of a max filter, a median filter, a root mean square filter, a mean filter, and an envelope filter.

19. The computing system of claim 16, further comprising performing a finite Fourier transform on the wavelet.

20. A non-transitory computer-readable medium storing instructions that, when executed by at least one processor of a computing system, cause the computing system to perform operations, the operations comprising:
receiving seismic data;
building a wavelet comprising a plurality of samples using the seismic data, wherein the wavelet includes a number of oscillations per sampling unit, and wherein a length of the wavelet corresponds to the number of oscillations;
time-shifting the wavelet;
scaling the wavelet after time-shifting the wavelet such that the samples proximate to one or both ends of the wavelet decay toward zero; and
scaling the wavelet such that an amplitude at a peak frequency of the wavelet, when transformed into a Fourier domain, is substantially unity.
